(19) United States
(12) Patent Application Publication
(10) Pub. No.: US 2022/0092559 A1
(43) Pub. Date: Mar. 24, 2022

(54) YARD CHECK SYSTEM WITH MAINTENANCE FEEDBACK FROM CUSTOMER

(71) Applicant: Schneider Enterprise Resources, LLC, Green Bay, WI (US)

(72) Inventors: Christopher Mossberg, Appleton, WI (US); Justin Sachs, Green Bay, WI (US); Stefanie Abitz-Grun, Green Bay, WI (US)

(21) Appl. No.: 17/480,649

(22) Filed: Sep. 21, 2021

Related U.S. Application Data
(60) Provisional application No. 63/081,515, filed on Sep. 22, 2020.

(51) Int. Cl. G06Q 10/00; G06Q 30/02

(52) U.S. Cl. CPC G06Q 10/20; G06Q 30/0282

(57) ABSTRACT

A system and method include identifying, by a yard check application, a maintenance operation to be performed on a trailer assigned to a customer. The identifying of the maintenance operation is performed based on customer feedback received from the customer via a customer portal of the customer. The system and method also include scheduling, by the yard check application, the maintenance operation on the trailer in response to the identifying of the maintenance operation.

### CROSS REFRENCE TO RELATED APPLICATION

This application claims the benefit of and priority to US Provisional Application No. 63/081,515, filed on Sep. 22, 2020, the entirety of which is incorporated by reference herein.

### BACKGROUND

Customers often use trailers to ship freight from one location to another. The trailers may be owned and/or operated by a carrier. Management of a customer's orders also entails management of the trailers allocated by the carrier to the customer. However, current mechanisms of integrating order management with trailer management are generally unknown, and to the extent that such mechanisms are known, such mechanisms are inadequate.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

In accordance with some embodiments of the present disclosure, a method is disclosed. The method includes identifying, by a yard check application, a maintenance operation to be performed on a trailer assigned to a customer, such that the identifying of the maintenance operation is performed based on customer feedback received from the customer via a customer portal of the customer. The method also includes scheduling, by the yard check application, the maintenance operation on the trailer in response to the identifying of the maintenance operation.

In accordance with further embodiments of the present disclosure, one or more non-transitory computer-readable storage media having computer-readable instructions stored thereon are disclosed. The computer-readable instructions when executed by a processor of a yard check application cause the processor to identify a maintenance operation to be performed on a trailer assigned to a customer, such that the identification of the maintenance operation is performed based on customer feedback received from the customer via a customer portal of the customer. The computer-readable instructions also cause the processor to schedule the maintenance operation on the trailer in response to the identification of the maintenance operation.

In accordance with further embodiments of the present disclosure, a system is disclosed. The system includes a yard check application having a processor that executes computer-readable instructions stored on a memory and a customer portal that is separate from the yard check application. The processor presents a user interface on the customer portal to receive customer feedback, identifies a maintenance operation to be performed on a trailer assigned to a customer associated with the customer portal, such that the identification of the maintenance operation is performed based on the customer feedback received via the customer portal, and schedules the maintenance operation on the trailer in response to the identification of the maintenance operation.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 is an example block diagram of a computing system implementing a yard check application, in accordance with some embodiments of the present disclosure.

FIG. 2 is an example block diagram showing additional details of the yard check application of FIG. 1, in accordance with some embodiments of the present disclosure.

FIG. 3 is an example flowchart outlining operations of a process for taking action based upon customer feedback, in accordance with some embodiments of the present disclosure.

FIG. 4 is another example flowchart outlining a process for requesting maintenance on a trailer via customer feedback, in accordance with some embodiments of the present disclosure.

FIGS. 5A and 5B are example user interfaces of the yard check application of FIG. 1 showing customer feedback for requesting maintenance on a trailer, in accordance with some embodiments of the present disclosure.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

A shipping yard, which also may be referred to as a container yard, a yard, a container port, a shipping terminal, etc., is a location where a trailer used for transporting freight may be temporarily stored. A trailer may be any storage box, van, wagon, or the like that may be used to store and move freight from one location to another. The trailer may be configured to be moved by any suitable transportation medium including road, air, rail, and/or water using any type of suitable transportation vehicle such as truck, train, air (planes/helicopters), intermodal (combination of transportation modes, such as truck and train), etc. It is to be understood that the terms “load,” “freight,” “cargo,” and “shipment” are used synonymously/interchangeably to describe goods transported in the trailers.

In some embodiments, a trailer may be owned and/or operated by a carrier. The carrier may allocate one or more trailers to a customer for transporting the customer's freight from one location to another pursuant to one or more orders. In some embodiments, the trailers allocated to the customer may be temporarily parked at a customer's yard to unload and/or load cargo during a delivery route. In some embodiments, the delivery route may include one or more source locations from where the trailer picks up freight and one or more destination locations where the trailer delivers the freight. In some embodiments, the trailers may be temporarily parked at the yard when the trailer is not currently in use (e.g., for maintenance or awaiting assignment to an order). In other embodiments, a trailer may stop at the yard when scheduled delivery routes and estimated delivery times for shipments change due to inclement weather, heavy traffic, road accidents, etc. For example, due to dangerous road conditions from an unexpected snowstorm, a trailer may stop at a yard.

Further, the customer may use an order management system or customer portal to manage the customer's orders. The order management system may be used to create, update, or otherwise manage existing and new orders, manage inventory, sales, etc. However, such order management systems are limited in their ability to manage trailers. For example, order management systems do not have the ability to request maintenance on trailers. Requesting maintenance on a trailer may be a time consuming process. In some cases, the customer may need to maintain the trailer itself by scheduling maintenance for the trailer, hauling the trailer to the maintenance facility (e.g., mechanic shop, dealer, etc.), waiting for the maintenance to be completed, and hauling the trailer back to the customer's yard. The customer may also need to fill out paper work or record the maintenance and/or inform the carrier. Thus, maintaining a trailer may be cumbersome and time consuming for the customer. If the customer has a large number of trailers, the problems above may be compounded.

In some cases, the carrier may have a trailer management system to manage its trailers allocated to the customer and to other customers. However, the trailer management system is not configured to integrate or interface with a customer's order management system. Thus, in some cases, instead of maintaining the trailer itself, the customer may reach out to the carrier so that the carrier may perform maintenance on the trailer. This may require the carrier to first figure out the type of maintenance needed on the trailer (which the person at the customer reaching out to the carrier may not know), and upon figuring out the type of maintenance, schedule maintenance. Depending upon the type of maintenance needed, the carrier may also need to haul the trailer from the customer's yard to perform the maintenance and haul the trailer back to the customer's yard after the maintenance. Upon receiving the maintenance request, the carrier may need to manually enter all the information into the trailer management system. In some cases, reaching out to the carrier to request maintenance, identifying the type of maintenance, and having the carrier pick up the trailer from the customer's yard may be time consuming for both the customer and the carrier, and may be undesirable. In some cases, the customer may not know when the carrier is picking up the trailer from the customer's yard for maintenance. For the foregoing reasons, the customer may avoid performing maintenance on the trailer or push the maintenance out as much as possible.

Thus, order management systems and trailer management systems suffer from technical problems that prevent the customer and carrier from properly maintaining trailers. The present disclosure provides technical solutions to integrate a customer's order management system with a carrier's trailer management system. The integrated order and trailer management system improves the operation and functioning of both the order management system and the trailer management system. Using the integrated order and trailer management system, maintenance on the trailers may be requested and scheduled easily and conveniently.

The integrated trailer management system and order management system may also be used to provide an accurate real-time or substantial real-time status of each trailer allocated to a customer. The integrated trailer management system and order management system may also provide an accurate and up-to-date view to the customer of where the customer's trailers are at any given point. For example, the integrated trailer management system and order management system may allow the customer to track the trailer location and/or status within shipping yards across several geographic locations (e.g., cities) and customer sites. The integrated trailer management system and order management system may also allow the customer easily assign trailers to orders, request pick-up of trailers to transport from the customer yard to a destination, and/or perform other actions.

Thus, the present disclosure provides a yard check application including a yard check engine that integrates a trailer management system with a customer's order management system. In some embodiments, the yard check application may be integrated with an existing order management system of the customer, thereby avoiding the need to reconfigure or recreate the customer's order management system. The yard check application may be configured to request and schedule maintenance on trailers. Integrating trailer management with order management may greatly save customers time and other resources in planning shipments and trailer allocation, loading trailers with cargo, unloading trailers, and so on by having real-time monitoring of the trailer and cargo status and locations, as well as easily maintaining their fleet of trailers.

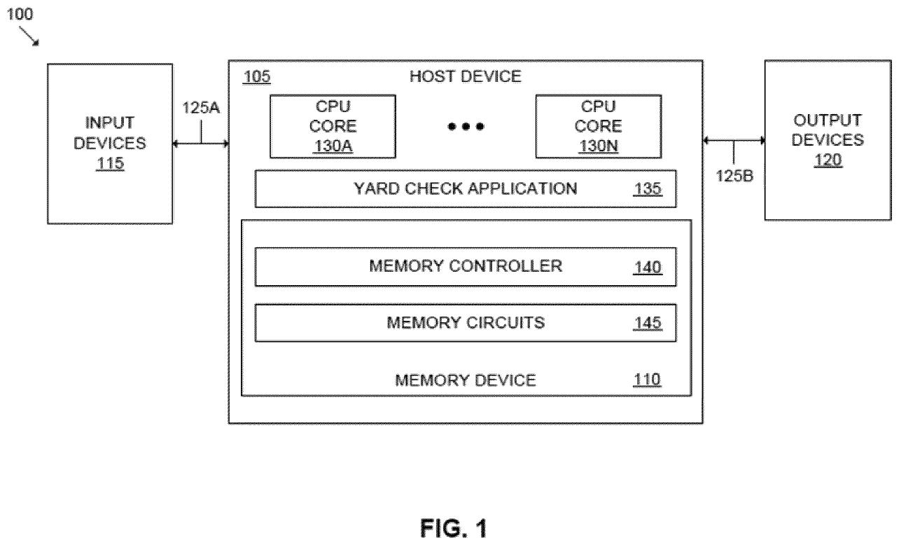

Referring now to FIG. 1, an example block diagram of a computing system 100 is shown, in accordance with some embodiments of the present disclosure. The computing system 100 includes a host device 105. The host device 105 includes a memory device 110. In other embodiments, the memory device 110 associated with the host device 105 is a separate device that is communicatively coupled to the host device 105 instead. The host device 105 may be configured to receive input from one or more input devices 115 and provide output to one or more output devices 120. The host device 105 may be configured to communicate with the input devices 115 and the output devices 120 via appropriate interfaces or channels 125A and 125B, respectively. The computing system 100 may be implemented in a variety of computing devices such as computers (e.g., desktop, laptop, etc.), tablets, personal digital assistants, mobile devices, wearable computing devices such as smart watches, other handheld or portable devices, or any other computing unit suitable for performing operations described herein using the host device 105.

Further, some or all of the features described in the present disclosure may be implemented on a client device, a server device, or a cloud/distributed computing environment, or a combination thereof. Additionally, unless otherwise indicated, functions described herein as being performed by a computing device (e.g., the computing system 100) may be implemented by multiple computing devices in a distributed environment, and vice versa. In some embodiments, the computing system 100 or at least some of the features described herein may be implemented in an in-vehicle system (e.g., tablet) that may be configured to implement at least some of the functions described herein and report those out to a server while, in other embodiments, the server may perform the functions.

The input devices 115 may include any of a variety of input technologies such as a keyboard, stylus, touch screen, mouse, track ball, keypad, microphone, voice recognition, motion recognition, remote controllers, input ports, one or more buttons, dials, joysticks, camera, and any other input peripheral that is associated with the host device 105 and that allows an external source, such as a user, to enter information (e.g., data) into the host device and send instructions to the host device 105. Similarly, the output devices 120 may include a variety of output technologies such as external memories, printers, speakers, displays, microphones, light emitting diodes, headphones, plotters, speech generating devices, video devices, global positioning systems, and any other output peripherals that are configured to receive information (e.g., data) from the host device 105. The “data” that is either input into the host device 105 and/or output from the host device may include any of a variety of textual data, graphical data, video data, image data, sound data, position data, sensor data, combinations thereof, or other types of analog and/or digital data that is suitable for processing using the computing system 100.

The host device 105 may include one or more Central Processing Unit (“CPU”) cores or processors 130A-130N that may be configured to execute instructions for running one or more applications associated with the host device 105. In some embodiments, the instructions and data needed to run the one or more applications may be stored within the memory device 110. The host device 105 may also be configured to store the results of running the one or more applications within the memory device 110. One such application on the host device 105 may include a yard check application 135. The yard check application 135 may be executed by one or more of the CPU cores 130A-130N. The instructions to execute the yard check application 135 may be stored within the memory device 110. The yard check application 135 is described in greater detail below. Thus, the host device 105 may be configured to request the memory device 110 to perform a variety of operations. For example, the host device 105 may request the memory device 110 to read data, write data, update or delete data, and/or perform management or other operations.

To facilitate communication with the memory device 110, the memory device 110 may include or be associated with a memory controller 140. Although the memory controller 140 is shown as being part of the memory device 110, in some embodiments, the memory controller 140 may instead be part of another element of the computing system 100 and operatively associated with the memory device 110. In some embodiments, the memory controller 140 may be configured as a logical block or circuitry that receives instructions from the host device 105 and performs operations in accordance with those instructions. For example, when the execution of the yard check application 135 is desired, the host device 105 may send a request to the memory controller 140. The memory controller 140 may read the instructions associated with the yard check application 135 that are stored within the memory device 110, and send those instructions back to the host device 105. Those instructions may be temporarily stored within a memory on the host device 105. One or more of the CPU cores 130A-130N may then execute those instructions by performing one or more operations called for by those instructions of the yard check application 135.

The memory device 110 may include one or more memory circuits 145 that store data and instructions. The memory circuits 145 may be any of a variety of memory types, including a variety of volatile memories, non-volatile memories, or a combination thereof. For example, in some embodiments, one or more of the memory circuits 145 or portions thereof may include NAND flash memory cores. In other embodiments, one or more of the memory circuits 145 or portions thereof may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D)(Point memory cores, ferroelectric random-access memory (FeRAM) cores, and other types of memory cores that are suitable for use within the memory device 110. In some embodiments, one or more of the memory circuits 145 or portions thereof may be configured as other types of storage class memory (“SCM”). Generally speaking, the memory circuits 145 may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

It is to be understood that only some components of the computing system 100 are shown and described in FIG. 1. However, the computing system 100 may include other components such as various batteries and power sources, networking interfaces, routers, switches, external memory systems, controllers, etc. Generally speaking, the computing system 100 may include any of a variety of hardware, software, and/or firmware components that are needed or considered desirable in performing the functions described herein. Similarly, the host device 105, the input devices 115, the output devices 120, and the memory device 110, including the memory controller 140 and the memory circuits 145, may include hardware, software, and/or firmware components that are considered necessary or desirable in performing the functions described herein. In addition, in certain embodiments, the memory device 110 may integrate some or all of the components of the host device 105, including, for example, the CPU cores 130A-130N, and the CPU cores may be configured to execute the yard check application 135, as described herein.

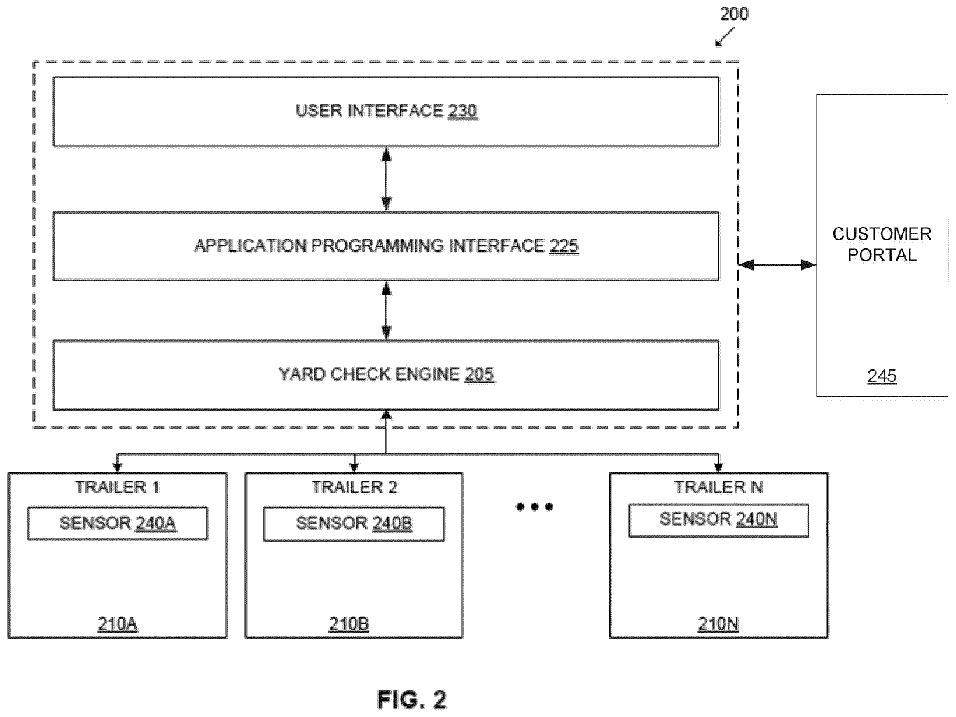

Turning now to FIG. 2, an example yard check application 200 is shown, in accordance with some embodiments of the present disclosure. The yard check application 200 is an example implementation of the yard check application 135 of FIG. 1. Thus, although not shown, the yard check application 200 may be associated with a host device (e.g., the host device 105) and other elements described above in FIG. 1. The yard check application 200 may be configured to perform a variety of operations. For example, in some embodiments, the yard check application 200 may be configured to track location and/or status of one or more trailers via a yard check engine 205 based upon sensor data received from one or more trailers 210A-210N (collectively referred to herein as “trailers 210”)). The yard check engine 205 may also be used to perform additional actions based upon the determined location and/or status of the trailers 210, as well as based on information received from a customer (e.g., customer feedback), as discussed in greater detail below.

The yard check application 200 may also include a user interface 230 that serves as the front end of the yard check application. In some embodiments, the yard check engine 205 may be accessed through the user interface 230 via an Application Programming Interface (“API”) 225. Specifically, to access the yard check engine 205 via the user interface 230 using the API 225, a user may use designated devices such as laptops, desktops, tablets, mobile devices, other handheld or portable devices, and/or other types of computing devices that are configured to access the API 225. In some embodiments, these devices may be different from the computing device on which the yard check application 200 is installed. In other embodiments, the yard check application 200 may be hosted on a cloud service and may be accessed through the cloud via a web or mobile application.

In some embodiments, the user may access the user interface 230/the yard check engine 205 via a web browser, upon entering a uniform resource locator (“URL”) for the API 225 such as the IP address of the yard check application 200 or other designated web address. In some embodiments, the user interface 230/the yard check engine 205 may be accessed via a mobile application downloaded to a mobile device. In other embodiments, the user interface 230/the yard check engine 205 may be configured for access in other ways. In some embodiments, a user of the yard check application 200 may be a provider of the yard check application or any personnel/entity to whom the provider makes the yard check application accessible. For example, in some embodiments, the user may be a provider of trailers, containers, or other storage equipment that may be used to ship cargo from one point to another. In other embodiments, the user may be a customer that uses those trailers, containers, etc. for shipment of their cargo. Generally speaking, the user of the yard check application 200 may be any personnel, company, or entity that may be interested at least in performing the functions described herein. It is to be understood that, while the present disclosure has been described with respect to the trailers 210, the present disclosure may also be applicable to other applications where real-time and accurate managing of a fleet is desired.

Further, upon accessing the user interface 230/the yard check engine 205, users may send instructions or queries to the yard check engine 205 and receive information back from the yard check engine via the user interface 230. Thus, the user interface 230 facilitates human-computer interaction between the users and the yard check engine 205. In some embodiments, the user interface 230 may present a graphical user interface (“GUI”) to a user to receive input from and provide output to the user. The GUI may present a variety of graphical icons, windows, visual indicators, menus, visual widgets, and other indicia to facilitate user interaction. In other embodiments, the user interface 230 may be configured as other types of user interfaces. Further, the user interface 230 may be configured to receive user inputs in a variety of ways. In some embodiments, the user interface 230 may be configured to receive user inputs via the input devices 115. In other embodiments, the user interface 230 may be configured to receive the user inputs in other ways. The user interface 230 may also be configured to present outputs/information to the users in a variety of ways. In some embodiments, the user interface 230 may present outputs to the user via the output devices 120. In other embodiments, the user interface 230 may be configured to present the outputs in other ways (e.g., audible, tactile, or visual alarms, etc.). Generally speaking, the user interface 230 may be associated with any type of hardware, software, and/or firmware component that enables the yard check application 200 to perform the functions described herein.

Further, in some embodiments, the API 225 that is used to communicate with the yard check engine 205 via the user interface 230 may be a representational state transfer (“REST”) type of API. In other embodiments, the API 225 may be any other type of web or other type of API (e.g., ASP.NET) built using any of a variety of technologies, such as Java, .Net, etc., that is suitable for facilitating communication between the yard check engine 205 and the users via the user interface 230. In some embodiments, the API 225 may be configured to facilitate communication via a hypertext transfer protocol (“HTTP”) or hypertext transfer protocol secure (“HTTPS”) type request. The API 225 may receive an HTTP/HTTPS request and send an HTTP/HTTPS response back. In other embodiments, the API 225 may be configured to facilitate communication using other or additional types of communication protocols.

It is to be understood that only some components of the yard check application 200 are shown and described in FIG. 2. However, the yard check application 200, including the yard check engine 205, may include or be associated with any of a variety of hardware, software, and/or firmware components that are needed or considered desirable in performing the functions described herein.

Referring still to FIG. 2 and as indicated above, the yard check engine 205 receives input from the trailers 210. In some embodiments, each of the trailers 210 may be a storage container or other types of nonautomotive wagon, box, or the like configured to be attached to a transportation vehicle for hauling freight from one destination to another. The shape, size, and other configuration details of each of the trailers 210 may vary from one embodiment to another. Further, the type of transportation vehicle to which the trailers 210 are attached may vary from one embodiment to another. For example, in some embodiments, the trailers 210 may be configured for transportation by road or rail. In other embodiments, the trailers 210 may additionally or alternatively be configured for transportation by water, air, or any other suitable modes of transportation. In some embodiments, the trailers 210 may be configured for transportation by a single mode of transportation. In other embodiments, the trailers 210 may be configured for intermodal transportation. Further, in some embodiments, each of the trailers 210 may be associated with a trailer type, a trailer location, a customer site location, a trailer identifier (e.g., a trailer identifier number and/or keyword), a trailer status, and/or any other information that may be considered necessary or desirable to have in identifying a trailer, the location and status of that trailer, the cargo that is carried or intended to be carried within that trailer, etc.

Additionally, in some embodiments, the trailers 210 may be located on a yard (e.g., of a customer) in between travel or for loading, maintenance, etc., or en-route. As described herein, a “yard” may refer to any area or site associated with a customer where a trailer may be parked for cargo loading and/or unloading, maintenance, or generally between travel. In some embodiments, each yard may be associated with a geo-fence area. In some embodiments, the geo-fence area of the yard may be provided as an input (e.g., as location coordinates (e.g., latitude and longitude coordinates)) to the yard check application 200 to enable the yard check engine 205 to identify a current location of the trailers 210. For example, if the yard check engine 205 determines that a trailer is within a geo-fenced area, the yard check engine may determine that the trailer is located on the yard. If the trailer is outside of the geo-fenced area, the yard check engine 205 may determine that the trailer is not on the yard. In some embodiments, the trailers 210 may all be located on a single yard. In other embodiments, the trailers 210 may be spread across multiple yard sites.

Further, in some embodiments, each of the trailers 210 is equipped with one or more sensors. For example and as shown in FIG. 2, in some embodiments, the trailer 210A may be equipped with a sensor 240A, the trailer 210B may be equipped with a sensor 240B, and so on. Although each of the trailers 210 is shown as having a single sensor, in other embodiments, one or more of those trailers may have multiple sensors. Further, the type of sensor or sensors on each of the trailers 210 may vary from one embodiment to another. For example, in some embodiments, one or more of the sensors 240A-240N (collectively referred to herein as “sensors 240”) may include temperature sensors, audio sensors, pressure sensors, inertial sensors such as accelerometers, light detection and illumination sensors, motion sensors, proximity sensors such as inductive, capacitive, ultrasonic, or photoelectric sensors, location sensors such as global positioning system (GPS) sensors, camera systems, video camera systems, lighting systems, and/or any other type of sensor(s) that may be used to determine the status and/or location of a trailer, the type of cargo within a trailer, and any other information that is desirable to collect from the trailers 210. The data collected by the sensors 240 may be utilized by the yard check engine 205 to determine a location and/or current status of the trailers 210. The sensors 240 may also be used to determine a type of cargo stored within the trailers 210.

Additionally, the location of the sensors 240 on the trailers 210 may vary from one embodiment to another. In some embodiments, the sensors 240 may be installed in the interior of the trailers 210 to generate sensor data regarding the inside of those trailers. For example, one or more cameras may be installed on the interior of the trailers 210 to take images of any cargo stored within those trailers. The cameras installed on the interior of the trailers 210 may also be used to determine whether the trailers are empty or loaded. Similarly, in some embodiments, other types of sensors may be installed on the interior of the trailers 210 to gather desired information from the interior of those trailers. In other embodiments, the sensors 240 may additionally or alternatively be installed on the exterior of the trailers 210. For example, cameras may be installed on the outside of the trailers 210 to collect image data of the areas surrounding the trailers. GPS sensors may also be installed on the exterior of the trailers 210. The location where the sensors 240 are installed on the interior and/or the exterior of the trailers 210 may vary from one embodiment to another. In some embodiments, the trailers 210, including the sensors 240, may form part of an internet of things (IoT) network that communicates data with the yard check engine 205 to monitor the trailers.

The sensors 240 may be configured to collect sensor data from the trailers 210 to which those sensors are mounted to. In some embodiments, the sensors 240 may be configured to collect sensor data continuously, while in other embodiments, the sensors 240 may be configured to collect data periodically. In some embodiments, the sensors 240 may be configured to store temporarily upon collection and/or transmit data periodically. In other embodiments, the sensors 240 may be configured to transmit the collected sensor data instantaneously or substantially instantaneously. Further, in some embodiments, the sensors 240 may be configured to communicate (e.g., to transmit the collected sensor data, to receive instructions, updates, etc. from the yard check engine 205, etc.) with the yard check engine 205 through one or more gateways or other suitable mechanisms. In some embodiments, one or more of the sensors 240 may also be configured to communicate with other sensors on the same trailer and/or with the sensors on other ones of the trailers 210. In some embodiments, the sensors 240 may be configured to communicate with other or additional components of the yard check application 200.

Additionally, in some embodiments, the sensors 240 may be configured to communicate (either with the yard check engine 205, other sensors, or any other component with which the sensors communicate with) using communication links including wired and/or wireless communication links such as jacks, antennas, transmitters, receivers, transceivers, wire terminals, electrical cables, connectors, network interfaces, switches, routers, etc. using communication protocols and channels such as TCP/INPUT, BACnet INPUT, BACnet MSTP, CAN Modbus, USB, Firewire, UART, SPI, RS-485, PSTN, Wi-Max, Bluetooth, LoRa, NFC, Zigbee, cellular or mobile phone communication channels (e.g., cellular 5G), wireless radio channels, local area network, metropolitan area network, wide area network, world wide web, internet, Ethernet, etc.

The yard check engine 205, upon receiving the sensor data, may store the sensor data from the sensors 240 within a memory (e.g., memory device 110). In some embodiments, the yard check engine 205 may be configured to store the sensor data indefinitely, while in other embodiments, the yard check engine may store the sensor data for a designated period of time before deleting that data. The yard check engine 205 may utilize the sensor data to perform one or more actions, as discussed below.

In some embodiments, the yard check application 200 may be configured to interface with a customer portal 245 of a customer that uses the trailers 210 for shipment of their cargo. In some embodiments, the customer portal 245 may be a separate application from the yard check application 200. The yard check application 200 may be configured to interface with the customer portal 245 to receive information from the customer portal and provide information to the customer portal. In other embodiments, the customer portal 245 may be part of the yard check application. Thus, in some embodiments, although shown separate from the yard check application 200, the customer portal 245 may be incorporated into the yard check application. In some embodiments, the customer portal 245 may be an order management system of the customer that is configured to manage the orders of the customer. For example, in some embodiments, the order management system may be used to create new orders, manage (view, modify, delete) existing or open orders, manage past orders, etc. Generally speaking, the order management system may enable the customer to track and manage sales, orders, and inventory of freight.

By integrating the customer portal 245 with the yard check application 200, the present disclosure provides an easy, convenient, and effective mechanism to the customer for managing the customer's trailers. For example, by integrating the customer portal 245 with the yard check application 200, a customer can easily assign a trailer to a new order, request maintenance of their existing trailers, view the current status of their current trailers, plan for future need in terms of the number of trailers that may be needed, etc. Similarly, by integrating the customer portal 245 with the yard check application 200, the yard check application may be able to provide a more accurate status of the customer's trailers, update or change status based on order information, manage maintenance of the fleet of transport vehicles that haul the trailers 210, manage pick up and drop off of the trailers at the customer site, etc.

Although not shown, the customer portal 245 may include a user interface similar to the user interface 230 to allow the customer to interact with the yard check application 200, one or more processing units (e.g., similar to the CPU cores 130A-130N), a memory device (e.g., similar to the memory device 110), and/or any other software, hardware, firmware, or combinations thereof that may be needed to perform the functions described herein. In some embodiments, the customer portal 245 may be generally provided by and/or maintained by the customer, while the yard check application 200 may be provided by and/or maintained by the carrier. By virtue of integrating the yard check application 200 with the customer's order management system, the yard check application may present on more interfaces/options on the customer portal 245 to receive input from the customer portal and provide output to the customer portal.

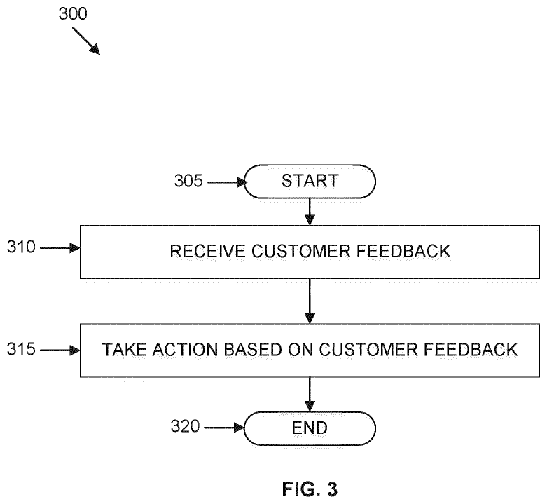

Turning now to FIG. 3, an example flowchart outlining a process 300 is shown, in accordance with some embodiments of the present disclosure. The process 300 may be implemented by the yard check engine 205 of the yard check application 200. The process 300 may be used to take action based upon customer feedback. Thus, upon starting at operation 305, the yard check engine 205 receives customer feedback at operation 310 about one or more of the trailers 210. In some embodiments, the customer feedback may be sent via the customer portal 245 to the yard check engine 205. In other embodiments, the customer feedback may be sent to the yard check engine 205 via other mechanisms. In some embodiments, the customer feedback may be manually input into the customer portal 245 for sending to the yard check engine 205. In other embodiments, the customer portal 245 may automatically send customer feedback when a certain condition is satisfied (e.g., a current status of a trailer changes).

Customer feedback may include information related to the trailers 210. For example, in some embodiments, the customer feedback may include information about a current status of the trailers 210. The term “status” may describe a current condition of the trailers 210. For example, the “status” may include whether the trailer is inbound, outbound, empty, or loaded. A trailer may have the status of “empty” if that trailer has no cargo loaded therein or if the trailer has no cargo loaded in greater than a predetermined percentage of the volume of the trailer. A trailer may have a status of “inbound” if that trailer has arrived at the customer's yard. A trailer may have a status of “outbound” if the trailer has been designated to depart from the yard (even though the trailer may not have been loaded yet). A trailer may have a status of “loaded” if that trailer is carrying at least some cargo or if that trailer has cargo loaded in greater than a predetermined percentage of the volume of that trailer. In some embodiments, the current status of a trailer may also include whether the trailer is located on a yard or en-route, location of the trailer on the yard, location of the trailer en-route, and other whereabouts of the trailer.

In some embodiments, the customer feedback may include an indication that a particular trailer that was previously empty has now been loaded. Similarly, in some embodiments, the customer feedback may include an indication that a particular trailer that was previously loaded is now empty. In other embodiments, the customer feedback may include an indication that a particular trailer has arrived at the yard, has departed the yard, has been designated to be loaded or unloaded at a future time, etc. The customer feedback may include other types of information pertaining to the trailers 210. In some embodiments, customer feedback may include requests to pick up a loaded trailer for transportation to a destination and/or to assign an empty trailer to an order. In some embodiments, the customer feedback may include maintenance requests on one or more trailers. Generally speaking, customer feedback may include any type of request, indication, notification, or information associated with a trailer or an order. Further, in some embodiments, the customer feedback may be sent continuously as soon as new information impacting a particular trailer is available, while in other embodiments, the customer feedback may be sent periodically (e.g., every few seconds, minutes, hours, etc.).

Upon receiving the customer feedback at the operation 310, the yard check engine 205 takes one or more actions based upon the customer feedback at operation 315. For example, based upon the customer feedback, the yard check engine 205 may update the current status of one or more of the trailers 210. In some embodiments, the yard check engine 205 may determine a current status of the trailers 210 based upon data collected by the sensors 240. In some embodiments, the sensor data that is collected from the sensors 240 may include data about the condition that the sensor is configured to detect (e.g., temperature, location, etc.), information on the time the data was collected/generated, a tag identifying the trailers 210 from which the data is collected, any identification or tag to identify the sensor that collected the data and the location of that sensor, and any other information that is considered necessary or desirable. In some embodiments, the sensor data may also be tagged with an approximate location (e.g., longitude and latitude/GPS coordinates, customer site, city/state, etc.) of the trailers 210. Upon receiving the sensor data, the yard check engine 205 may be able to associate the sensor data to a particular one of the trailers 210 from which the data is collected, as well as a current location of the particular trailer.

In some embodiments, the yard check engine 205 may determine the current status of the trailers 210 by analyzing the sensor data using machine learning or artificial intelligence algorithms. In other embodiments, the yard check engine 205 may use image processing techniques to compare sensor data (e.g., an image from an infrared camera, an image from an external camera mounted on a nearby building, etc.) to a baseline image of the trailers 210 to determine a current status of the trailers. In yet other embodiments, the yard check engine 205 may use a combination of machine learning/artificial intelligence algorithms and image processing to determine the status of the trailers 210. In some embodiments, the yard check engine 205 may also determine, based on the sensor data, whether a particular one of the trailers 210 is situated on a customer yard or outside of the customer yard by comparing the current location of the particular trailer (e.g., from GPS sensor data) to the location of a geo-fence of the customer yard. Additional details about determining the current status of the trailers 210 may be found in U.S. application Ser. No. 16/881,834, filed on May 22, 2020, the entirety of which is incorporated by reference herein.

In some embodiments, the yard check engine 205 may update the current status determined based on the sensor data using the customer feedback received at the operation 310. For example, in some embodiments, the yard check engine 310 may receive customer feedback that a particular one of the trailers 210 has departed the customer yard. Based on that customer feedback, the yard check engine 205 may update the current status of that particular trailer to indicate that the particular trailer is now en-route. Augmenting the current status of a particular trailer based on the customer feedback may provide a more accurate current status of the trailer. In some embodiments, the current status of a particular trailer may be determined/updated based upon sensor data periodically. Customer feedback may be particularly beneficial in updating the current status of the trailer if the status changes between two sensor readings.

In some embodiments, based upon the customer feedback, the yard check engine 205 may assign a trailer to an order, schedule pick up of a trailer for maintenance or transportation to a destination, schedule maintenance of the trailer, etc. The yard check engine 205 may also store the customer feedback within the memory device 110. Thus, based on customer feedback, the yard check engine 205 may perform one or more actions. The process 300 ends at operation 320 waiting for the next set of customer feedback.

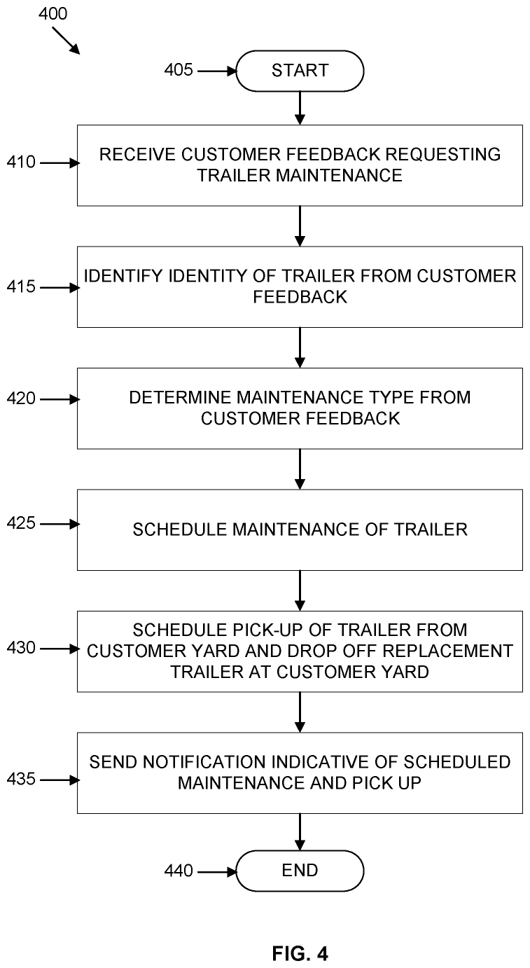

Referring now to FIG. 4, a flowchart outlining operations of a process 400 is shown, in accordance with some embodiments of the present disclosure. In some embodiments, the process 400 may be implemented via the yard check engine 205 of the yard check application 200. The process 400 may be used to request maintenance on a trailer based on customer feedback. A customer may have multiple trailers to ship their freight. Some trailers may already be allocated to orders, while others may be sitting empty waiting for an order assignment. Trailers may require regular (e.g., after traveling a certain distance, passing of a predetermined time period, etc.) maintenance to extend the life of the trailers, to maintain compliance with regulations, or to otherwise ensure the safety of those trailers during use, as well as the safety of personnel operating those trailers. Trailers may suffer normal wear and tear during use. Maintenance or repair may be needed to fix such normal wear and tear. In some cases, maintenance may be elective. Generally speaking, maintenance may include any required or desired repair, tune-up, replacement or changing, check-up, fixing, or other types of servicing on the trailers to keep the trailers in a proper, operational, and safe to operate state. Example maintenance operations may include replacing and/or rotating tires on the trailers, fixing and/or changing paint, adding and/or replacing sensors, repairing suspension, frame, roof, doors, brakes, bumpers, slider, landing gear, or other equipment of the trailer, replacing lights, etc.

In some cases, to request maintenance on a trailer, the customer may need to call the carrier (e.g., provider and/or owner of the trailer). If the carrier is not available or accessible for some reason, the maintenance on the trailer may be delayed. If maintenance is delayed, the trailer may become unusable for a period of time until maintenance may be completed, while continuing to occupy space on the customer's yard. An unusable trailer may also result in delay in shipping out freight, and therefore fulfilling orders in a timely manner. In some cases, the onus may be on the customer to perform maintenance on the trailers assigned thereto. Maintaining trailers itself may be burdensome for the customer and generally undesirable. In some cases, the carrier may prohibit the customer from performing maintenance on the trailers. The process 400 may allow a customer to easily and conveniently request maintenance on a trailer using customer feedback, thereby ensuring timely maintenance of the trailers in a seamless manner.

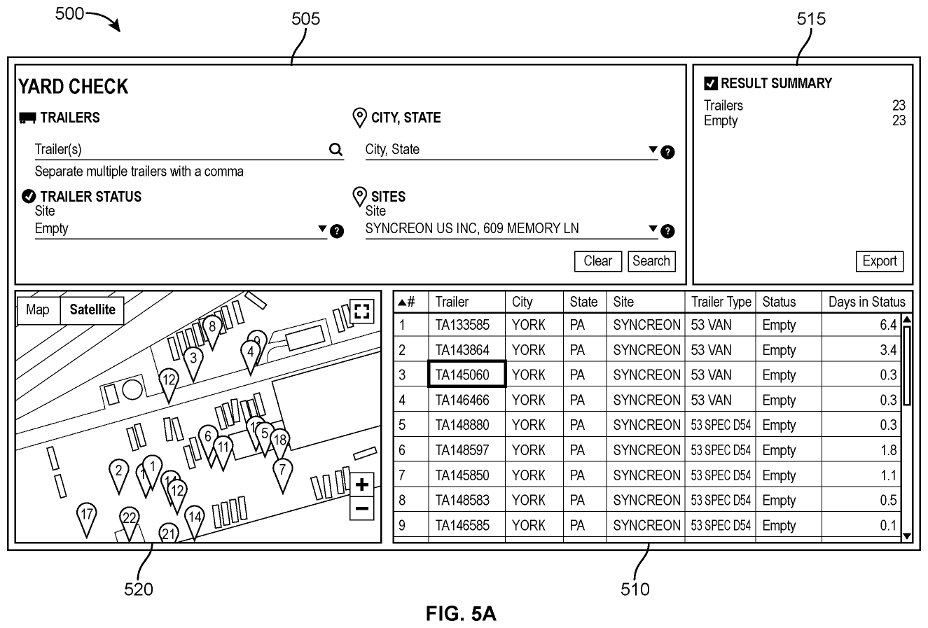

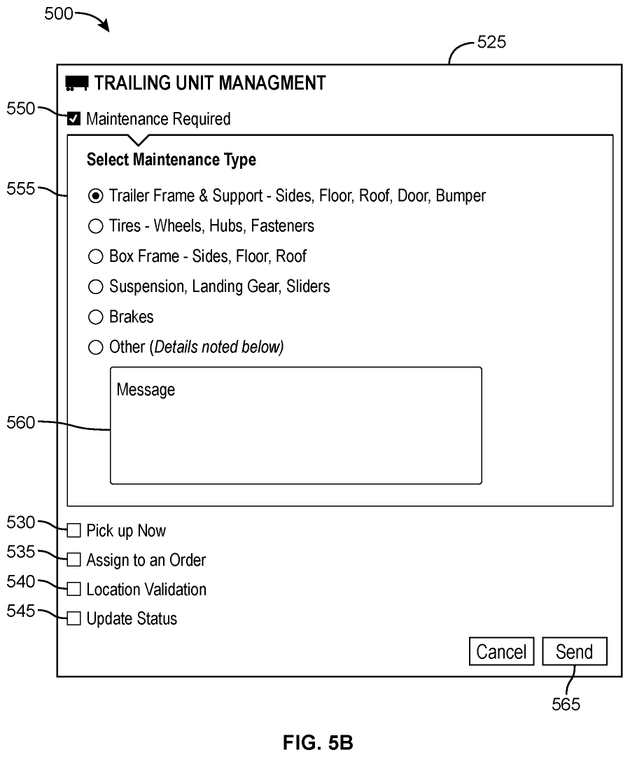

Thus, the process 400 starts at operation 405 when the customer desires to request maintenance on a trailer. At operation 410, the yard check engine 205 receives customer feedback from the customer. In some embodiments, the customer may send the customer feedback to the yard check engine 205 via the customer portal 245. In some embodiments, the yard check engine 205 may present a specific user interface (discussed in FIGS. 5 and 6 below) on the customer portal 245 that enables the customer to request maintenance. In some embodiments, the customer feedback to request maintenance may include certain type of information. For example, in some embodiments, the customer feedback to request maintenance may include the identity of the trailer or trailers on which maintenance is desired/required, the type of maintenance that is desired/required, and any other information that may be needed or considered desirable to have in maintaining the trailer. In some embodiments, separate customer feedback may be used to request maintenance for different trailers. In other embodiments, with the same customer feedback, the customer may request maintenance on multiple trailers.

Upon receiving the customer feedback at the operation 410, the yard check engine 205 determines the identity of the trailer that requires maintenance at operation 415. In some embodiments, the customer feedback may include an identity of the trailer(s) on which maintenance is requested. In some embodiments, the customer may assign each of the trailers 210 assigned thereto an identification code (e.g., first form of identification) to uniquely identify and distinguish each trailer from another trailer assigned to the customer. In some embodiments, the identification code may be different from the identification codes (e.g., second form of identification) used by the carrier for those trailers. In some embodiments, the carrier may maintain a mapping of customer's identification codes to the carrier's identification codes. Thus, upon receiving the customer feedback including the customer's identification code for the trailer, the yard check engine 205 may determine the carrier's identification code for that trailer based on the mapping. In other embodiments, the customer and the carrier may use the same identification codes. In such embodiments, the yard check engine 205 may simply determine the identity of the trailer directly from the customer feedback. In other embodiments, the yard check engine 205 may determine the identity of the trailer on which maintenance is requested in other ways.

In some embodiments, the carrier may be associated with multiple customers. Thus, in some embodiments, the yard check engine 205 may also need to determine the identity of the customer requesting maintenance at the operation 410. In some embodiments, and particularly if customers assign their own unique identification codes to the trailers, the yard check engine 205 may determine the identity of the customer from the identification codes included in the customer feedback. In other embodiments, the customer feedback may include an identity (e.g., customer code, etc.) of the customer. In other embodiments, the yard check engine 205 may determine the customer identity from the Internet Protocol (IP) address of the customer portal 245 or from where the customer feedback is sent. In yet other embodiments, the yard check engine 205 may use other mechanisms to determine the customer identity.

At operation 420, the yard check engine 205 determines the type of maintenance that is requested. In some embodiments, the yard check engine 205 may present on the customer portal 245 a list of commonly requested maintenance operations. The customer may select one or more maintenance operations from that list and send that as part of the customer feedback at the operation 410. In some embodiments, each maintenance operation may be assigned a unique code that enables the yard check engine 205 to identify the type of maintenance that is requested. Thus, upon receiving the selections from the list from the customer portal 245, the yard check engine 205 may easily determine the type of maintenance needed.

In other embodiments, in addition to or instead of selecting from a list, the yard check engine 205 may present on the customer portal 245 options to provide a description of the specific maintenance operation being requested, add images, videos, sounds, sensor readings, etc. (e.g., by taking pictures, videos, recording sounds etc. using a cellphone and uploading to the customer portal) to validate/highlight issues with a trailer, and/or provide other options to indicate the type of maintenance operation requested. In some embodiments, the customer may not know what type of maintenance is needed. In such embodiments, the yard check engine 205 may present on the customer portal 245 options which allow the customer to simply describe (e.g., using text, images, videos, sounds, etc.) the problems facing a trailer, and send that description to the carrier via the customer portal 245. The customer feedback may include any other information that may be needed or considered desirable to have in identifying the type of maintenance. The yard check engine 205 may determine, from such customer feedback, the type of maintenance that is needed. In some embodiments, the yard check engine 205 may identify keywords from the customer feedback to determine the type of maintenance needed. In some embodiments, the yard check engine 205 may rely on machine learning/artificial intelligence to parse the customer feedback to determine the type of maintenance needed, as well as any other information (e.g., trailer identity, etc.). In other embodiments, the yard check engine 205 may determine the type of maintenance needed from customer feedback in other ways.

In some embodiments, the customer feedback may also include a timeline for the maintenance operation. For example, in some embodiments, the customer may want to assign the trailer to a particular order and may want the maintenance completed before the ship date of the order. Thus, the customer feedback may include a timeline requesting the maintenance to be completed by a certain date. In some embodiments, the customer feedback may request maintenance operations that are not currently due but are expected to become due in the foreseeable future, thereby allowing the customer to schedule maintenance in advance. For example, if a trailer needs new sensors and the trailer is inbound, the customer may request maintenance on the trailer in advance. The customer feedback may include a timeline of when the trailer is expected to be back at the customer's yard. Similarly, the customer feedback may include other types of time related deadlines for the maintenance requests.

Upon identifying the type of maintenance needed, at operation 425, the yard check engine 205 may automatically schedule maintenance of the trailer. In some embodiments, scheduling maintenance may include scheduling an appointment with a designated dealer, repair shop, carrier's in-house trailer maintenance department, and/or any other entity that is suitable for performing the type of maintenance identified at the operation 420. In some embodiments, the yard check engine 205 may be configured to send a notification to a designated personnel with the information (e.g., customer identity, trailer identity, maintenance type, etc.) gleaned from the customer feedback and the designated personnel may then schedule the maintenance on the trailer. In other embodiments, the yard check engine 205 may have access to the calendar of the entity that is to perform the maintenance and the yard check engine may add the maintenance to the calendar automatically. In some embodiments, the yard check engine 205 may determine that new or replacement parts and/or supplies are needed before the maintenance may be completed. In such embodiments, the yard check engine 205 may be configured to order parts and/or supplies either directly or indirectly through a designated personnel (e.g., send a notification to the designated personnel who may then request the part/supplies). The yard check engine 205 may be configured to take other preparatory actions that may be needed to facilitate scheduling of the maintenance and/or before performing the maintenance. Thus, the yard check engine 205 may be configured to streamline the maintenance of the trailers.

At operation 430, the yard check engine 205 may also schedule a pick-up of the trailer from the customer's yard. In some embodiments, the yard check engine 205 may automatically contact designated personnel responsible for transporting the trailer to and from the customer's yard. If the customer feedback indicated that the customer requested a replacement trailer, the yard check engine 205 may also assign a replacement trailer to the customer and schedule a drop off of that replacement trailer to the customer's yard. In some embodiments, the yard check engine 205 may determine that the maintenance on the trailer may not be completed by the requested timeline. In such cases, the yard check engine 205 may assign a replacement trailer to the customer even if the customer did not specifically request a replacement. In some embodiments, the yard check engine 205 may be configured to assign and drop off a replacement trailer any time a trailer has to be removed from the customer's yard for maintenance to maintain customer's continuity of operation. In some embodiments, the yard check engine 205 may schedule the maintenance to be performed at the customer's yard in which case removal of the trailer from the customer's yard may not be needed. For example, in some embodiments, instead of picking up the trailer on which maintenance is to be performed from the customer's yard, the yard check engine 205 may schedule a service truck to be sent to the customer's yard for repairing/fixing the trailer at the customer's yard. In other embodiments, the yard check engine 205 may be configured to take other actions.

Upon scheduling maintenance, scheduling pick-up of the trailer from the customer yard, and scheduling drop-off of a replacement trailer at the customer's yard, as discussed above, the yard check engine 205 optionally sends a notification to the customer at operation 435. In some embodiments, the notification may include the type of maintenance that is to be performed, the pick-up date, whether a replacement trailer is being provided, the time line for completing maintenance, the time line for dropping of the replacement trailer, and any other information that may be needed or considered desirable. The process 400 then ends at operation 440 waiting for the next customer feedback requesting maintenance.

Referring now to FIGS. 5A and 5B, an example user interface 500 is shown, in accordance with some embodiments of the present disclosure. The user interface 500 may be accessed via the customer portal 245 and may be used to request maintenance on a trailer assigned to the customer. It is to be understood that the configuration of the user interface 500 is only an example and may vary in other embodiments. In some embodiments, the user interface 500 may be generated by the yard check engine 205 and displayed (e.g., presented) on the customer portal 245. The user interface 500 may show a list of trailers assigned to the customer. In some embodiments, the customer may filter the list of trailers using one or more filters shown in a first portion 505 of the user interface 500. In some embodiments, the filtered or unfiltered set of trailers may be displayed in a second portion 510. The user interface 500 may show additional information of the trailers. For example, a third portion 515 of the user interface 500 may show a status summary of the set of trailers displayed in the second portion 510. In some embodiments, a map 520 may show a current location of each of the trailers shown in the second portion 510. In other embodiments, the user interface 500 may show additional or other features.

From the list of trailers displayed in the second portion 510, the customer may select (e.g., by clicking) a trailer on which maintenance is to be requested. Upon selecting a trailer, a dialog box 525 shown in FIG. 5B may be opened. The dialog box 525 may present a variety of options/actions to be performed on the selected trailer. For example, in some embodiments, the dialog box 525 may present a pick up now option 530 using which the customer may schedule a pick-up with the carrier of a loaded trailer from the customer's yard to be transported to a destination. The dialog box 525 may also present an assign to an order option 535 to allow the customer to assign the selected trailer to an order, a location validation option 540 to determine/confirm the location of the selected trailer, including location of the trailer on the yard, and an update status option 545 to update a current status of the trailer. The dialog box 525 may also present maintenance required option 550 to request maintenance on the selected trailer. In other embodiments, the dialog box 525 may be configured to present other or additional options.

Thus, the dialog box 525 allows the customer to provide customer feedback. To request maintenance on the selected trailer, the customer may select the maintenance required option 550 to display a list 555 of common maintenance types. The customer may select one or more options from the list 555. The list 555 is only an example and the options displayed therein in FIG. 5B may vary in other embodiments. In some embodiments, the customer may additionally or alternatively add a description in message box 560. The list 555 and the message box 560 allow the user to simply and easily request maintenance on the selected trailer. Although not shown, in some embodiments, the dialog box 525 may provide a feature to upload various images, videos, sounds, etc., and add any other information that may be needed or considered desirable to have. Upon clicking on a send button 565, the maintenance request, including all of the information selected by the customer in the user interface 500 and the dialog box 525 is sent to the yard check engine 205.

Thus, the present disclosure provides a convenient and effective mechanism to integrate a customer's portal (e.g., the customer portal 245) with a trailer management system (e.g., the yard check engine 205). The yard check engine 205 of the present disclosure provides a convenient mechanism to schedule maintenance on a trailer.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method comprising:
identifying, by a yard check application, a maintenance operation to be performed on a trailer assigned to a customer, wherein the identifying of the maintenance operation is performed based on customer feedback received from the customer via a customer portal of the customer; and
scheduling, by the yard check application, the maintenance operation on the trailer in response to the identifying of the maintenance operation.

2. The method of claim 1, wherein the customer feedback comprises an identity of the trailer on which the maintenance operation is to be performed.

3. The method of claim 1, wherein the customer feedback comprises a maintenance type associated with the maintenance operation to be performed on the trailer.

4. The method of claim 1, further comprising automatically scheduling, by the yard check application, a pick-up of the trailer from a yard of the customer for performing the maintenance operation.

5. The method of claim 4, further comprising, automatically scheduling, by the yard check application, a drop-off of the trailer back at the yard after completion of the maintenance operation.

6. The method of claim 1, further comprising automatically scheduling, by the yard check application, a drop off of a replacement trailer at a yard of the customer in response to scheduling the maintenance operation.

7. The method of claim 1, wherein the identifying of the maintenance operation comprises, determining, by the yard check application, an identity of the trailer from the customer feedback.

8. The method of claim 1, wherein the identifying of the maintenance operation comprises, determining, by the yard check application, a maintenance type from the customer feedback.

9. The method of claim 1, further comprising, presenting, by the yard check application, a user interface on the customer portal to receive the customer feedback.

10. The method of claim 9, wherein the user interface presents a list of maintenance options to be selected for requesting the maintenance operation on the trailer, and wherein the yard check application receives a selection of at least one option from the list of maintenance options as the customer feedback.

11. The method of claim 9, wherein the yard check application presents the user interface in response to receiving selection of the trailer from a list of trailers from the customer portal.

12. The method of claim 11, wherein the user interface presents a list of actions to be performed on the trailer, wherein the list of actions include at least a maintenance required option to request the maintenance operation on the trailer, a pick up now option to request the trailer to be picked up from a yard of the customer for transportation to a destination, an assign to an order option for assigning the trailer to an order, a location validation option to validate a location of the trailer, or an update status option to update a current status of the trailer.

13. The method of claim 1, wherein the customer portal is separate from and associated with the yard check application.

14. One or more non-transitory computer-readable storage media comprising computer-readable instructions stored thereon that when executed by a processor of a yard check application cause the processor to:
identify a maintenance operation to be performed on a trailer assigned to a customer, wherein the identification of the maintenance operation is performed based on customer feedback received from the customer via a customer portal of the customer; and
schedule the maintenance operation on the trailer in response to the identification of the maintenance operation.

15. The one or more non-transitory computer-readable storage media of claim 14, wherein the processor further executes the computer-readable instructions to:
identify an identity of the trailer from the customer feedback; and
identify a maintenance type from the customer feedback.

16. The one or more non-transitory computer-readable storage media of claim 14, wherein the customer portal is separate from and associated with the yard check application.

17. The one or more non-transitory computer-readable storage media of claim 14, wherein the customer feedback comprises at least an identity of the trailer or a maintenance type indicative of the maintenance operation to be performed on the trailer.

18. The one or more non-transitory computer-readable storage media of claim 14, wherein the processor further executes the computer-readable instructions to:
present a user interface on the customer portal to receive the customer feedback; and
present a list of maintenance options on the user interface to receive a selection therefrom as the customer feedback.

19. A system comprising:
a yard check application comprising a processor that executes computer-readable instructions stored on a memory; and
a customer portal that is separate from the yard check application,
wherein the processor presents a user interface on the customer portal to receive customer feedback;
wherein the processor identifies a maintenance operation to be performed on a trailer assigned to a customer associated with the customer portal, wherein the identification of the maintenance operation is performed based on the customer feedback received via the customer portal; and
wherein the processor schedules the maintenance operation on the trailer in response to the identification of the maintenance operation.

20. The system of claim 19, wherein the processor presents a user interface on the customer portal for receiving the customer feedback.
